(19) United States
(12) Patent Application Publication
(10) Pub. No.: US 2020/0079268 A1
(43) Pub. Date: Mar. 12, 2020

(54) CARBON FIBER PICK UP BOX

(71) Applicant: GM GLOBAL TECHNOLOGY OPERATIONS LLC, Detroit, MI (US)

(72) Inventor: Jeffrey R. Sulik, Warren, MI (US)

(21) Appl. No.: 16/123,155

(22) Filed: Sep. 6, 2018

(51) Int. Cl. B60P 3/06; B62D 29/04; B62D 33/02; B62D 25/20

(52) U.S. Cl. CPC B60P 3/062; B62D 25/2072; B62D 33/02; B62D 29/043

(57) ABSTRACT

A carbon fiber pickup box floor includes a plurality of integrally formed slide grooves extending longitudinally between the front and rear ends of the box floor configured for providing a glide surface for snowmobile ski carbides, wherein the plurality of integrally formed slide grooves are disposed at predetermined portions of the box floor

### FIELD

The invention relates generally to pickup truck boxes, and more particularly to a pickup truck carbon fiber box having integrated snowmobile ski slides.

### BACKGROUND

The statements in this section merely provide background information related to the present disclosure and may or may not constitute prior art.

Snowmobiling is a major winter recreational activity and a significant factor in increased winter tourism in several locations in many winter regions. Snowmobiling is great exercise that brings people outdoors to interact with nature and each other. It is an invigorating sport that is great for stress relief and good mental health.

Transporting a snowmobile by using a trailer or by loading it in to the box of a pickup truck. However, it is known that the carbides disposed on the bottom of the snowmobile skis make it difficult to slide the machines in and out of the pickup box and they have a tendency to cause damage to the box floor. Preventing such damage requires the purchase of box liner or ski glides which makes it easier to slide the machine in and out of the box.

For transporting snowmobiles in a pickup truck box it is desirable to have a means to avoid the need to purchase box floor protection to prevent damage caused by the abrasive ski carbides.

### SUMMARY

One or more exemplary embodiments address the above issue by providing a pickup truck carbon fiber box having integrated snowmobile ski slides.

According to an aspect of an exemplary embodiment, a carbon fiber pickup box floor includes a plurality of integrally formed slide grooves extending longitudinally between the front and rear ends of the box floor configured for providing a glide surface for snowmobile ski carbides, wherein the plurality of integrally formed slide grooves are disposed at predetermined portions of the box floor.

A further aspect in accordance with the exemplary embodiment is provided wherein the predetermined portions of the box floor are substantially 1220 millimeters apart. And another aspect wherein the predetermined portions of the box floor are substantially 125 millimeters in width. Still another aspect wherein the predetermined portions of the box floor comprises between four and seven slide grooves. And yet another aspect wherein the depth of the slide grooves is substantially 16 millimeters. And still another aspect wherein the width of the slide grooves is substantially 19 millimeters. And one other aspect wherein the slide grooves are separated substantially 7 millimeters apart.

Further features, aspects and advantages of the present invention will become apparent by reference to the following description and appended drawings wherein like reference numbers refer to the same component, element or feature.

### DRAWINGS

The drawings described herein are for illustration purposes only and are not intended to limit the scope of the disclosed exemplary embodiments in any way.

FIG. 1 is an illustration of a snowmobile in a pickup box in accordance with aspects of an exemplary embodiment;

FIG. 2 is an illustration of a pickup box having a plurality of integrally formed slide grooves in accordance with the exemplary embodiment; and

FIG. 3 is a cross sectional view (A-A) of the plurality of integrally formed slide grooves of FIG. 2 in accordance with aspects of the exemplary embodiment.

### DETAILED DESCRIPTION

The following description is merely exemplary in nature and is not intended to limit the present disclosure, application, or uses.

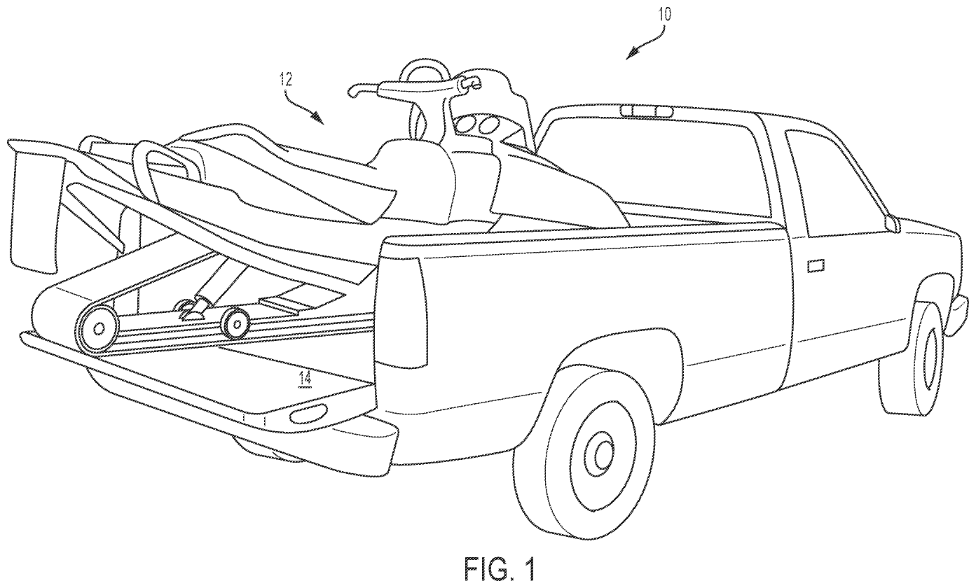

With reference to FIG. 1, an illustration of a snowmobile 12 in a pickup box 14 in accordance with aspects of an exemplary embodiment is presented. Loading and unloading a snowmobile in a pickup box requires the use of appropriately designed ramps that have adequate strength and can provide a grip surface for the snowmobile 12 to be propelled up the incline of the ramp onto the pickup box floor 14. It is known that the bottom surface of snowmobile skis often include carbides which are used primarily for providing a more durable wear surface for the skis and the sharp edge of the carbide is helpful on an icy surfaces.

After a snowmobile has transgressed the loading ramps for transport in the pickup box, it will most likely be difficult for the machine to slide onto the pickup box floor without causing damage due to the carbides on the bottom surface of the skis. Currently anyone that transports a snowmobile in the box of their pickup truck will have to purchase an aftermarket box liner or have a protective liner sprayed on the box floor which does not work well because it does not let the machine slide easily into and out of the pickup box. Thus, the present disclosure seeks to provide a pickup box that incorporates deep grooved ski glides into the floor of a carbon fiber pickup box which protects the load floor from damage and allows the machine to be easily slid in and out of pickup box.

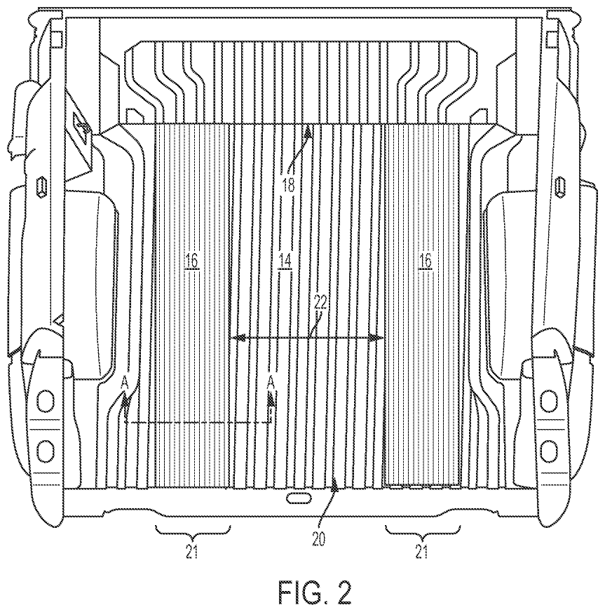

Referring now to FIG. 2, an illustration of a pickup box 14 having a plurality of integrally formed slide grooves 16 extending longitudinally between the front 18 and rear 20 ends of the box 14 floor configured for providing a glide surface for snowmobile ski carbides, wherein the plurality of integrally formed slide grooves 16 are disposed at predetermined portions 21 of the box 14 floor in accordance with the exemplary embodiment. The pickup box 14 is formed of a carbon fiber material and the predetermined portions 21 are spaced apart at a predetermined distance 22 which, in accordance with one embodiment, is substantially 1220 millimeters apart.

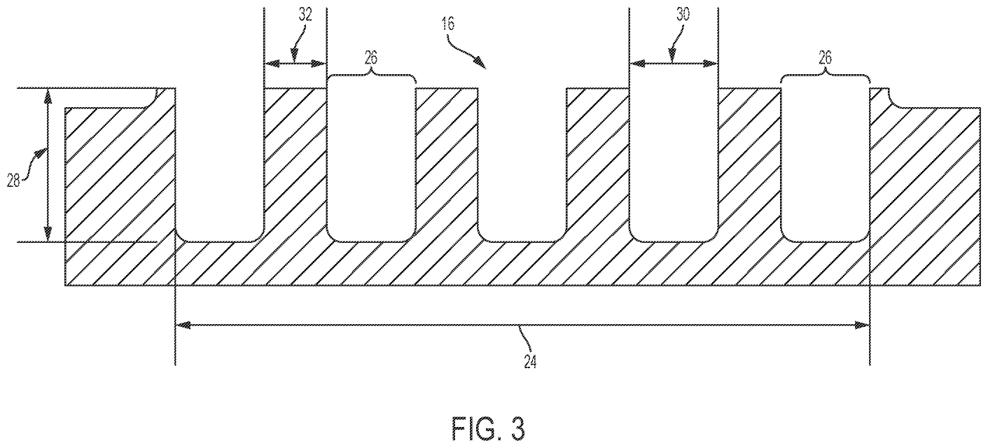

FIG. 3 is a cross sectional view (A-A) of the plurality of integrally formed slide grooves 16 of FIG. 2. In one embodiment, the plurality of integrally formed slide grooves 26 consists of a pattern of 4 to 7 grooves which span a predetermined width 24. In one embodiment, the predetermined width 24 is substantially 125 millimeters wide. It is appreciated that more or less grooves may be used without exceeding the scope of this disclosure. Also in accordance with an exemplary embodiment, the depth of a slide groove 26 is substantially 16 millimeters (28), the width of a slide groove 26 is substantially 19 millimeters (30), and wherein the slide grooves 26 are separated substantially 7 millimeters (32) apart. As described, a pickup box that incorporates deep grooved ski glides into the floor of a carbon fiber pickup box which protects the load floor from damage and allows the machine to be easily slid in and out of pickup box is provided.

The description of the invention is merely exemplary in nature and variations that do not depart from the gist of the invention are intended to be within the scope of the invention. Such variations are not to be regarded as a departure from the spirit and scope of the invention.

What is claimed is:

1. A carbon fiber pickup box floor comprising:
a plurality of integrally formed slide grooves extending longitudinally between the front and rear ends of the box floor configured for providing a glide surface for snowmobile ski carbides, wherein the plurality of integrally formed slide grooves are disposed at predetermined portions of the box floor.

2. The pickup box of claim 1 wherein the predetermined portions of the box floor are substantially 1220 millimeters apart.

3. The pickup box of claim 2 wherein the predetermined portions of the box floor are substantially 125 millimeters in width.

4. The pickup box of claim 3 wherein the predetermined portions of the box floor comprises between four and seven slide grooves.

5. The pickup box of claim 4 wherein the depth of the slide grooves is substantially 16 millimeters.

6. The pickup box of claim 5 wherein the width of the slide grooves is substantially 19 millimeters.

7. The pickup box of claim 6 wherein the slide grooves are separated substantially 7 millimeters apart.
